(19) United States
(12) Patent Application Publication
(10) Pub. No.: US 2020/0175471 A1
(43) Pub. Date: Jun. 4, 2020

(54) VEHICLE AND DELIVERY SYSTEM

(71) Applicant: TOYOTA JIDOSHA KABUSHIKI KAISHA, Toyota-shi (JP)

(72) Inventors: Ayano TSURUTA, Toyota-shi (JP); Yasuhiro HARA, Nagoya-shi (JP); Junya WATANABE, Nagakute-shi (JP); Kenta MIYAHARA, Toyota-shi (JP); Nana KIKUIRE, Toyota-shi (JP)

(73) Assignee: TOYOTA JIDOSHA KABUSHIKI KAISHA, Toyota-shi (JP)

(21) Appl. No.: 16/671,764

(22) Filed: Nov. 1, 2019

(30) Foreign Application Priority Data
Dec. 4, 2018 (JP) 2018-227697

(51) Int. Cl. G06Q 10/08; B64C 39/02; B60P 3/11; B60P 3/08

(52) U.S. Cl. CPC G06Q 10/0834; B64C 39/024; G06Q 10/0838; B60P 3/08; B60P 3/11

(57) ABSTRACT

A vehicle including: a first bay configured to accommodate a ground-based moving body; a second bay configured to accommodate a flying moving body; a cargo hold connected to both the first bay and the second bay, and configured to store a package to be moved to either the ground-based moving body or the flying moving body; a first memory; and a first processor connected to the first memory, the first processor being configured to select whether to move the package in the cargo hold to the ground-based moving body or the flying moving body.

### CROSS-REFERENCE TO RELATED APPLICATION

This application is based on and claims priority under 35 USC 119 from Japanese Patent Application No. 2018-227697 filed on Dec. 4, 2018, the disclosure of which is incorporated by reference herein.

### BACKGROUND

### Technical Field

The present disclosure relates to a vehicle and a delivery system for delivering a package.

### Related Art

US Patent Application Publication No. 2018/0137454 discloses a logistics system employing an autonomous traveling vehicle (for example a traveling robot) configuring a ground-based moving body, and an unmanned aerial vehicle (for example a drone) configuring a flying moving body.

In this logistics system, a package is delivered from a distribution center to a relay point by the unmanned aerial vehicle, and is delivered from the relay point to a delivery site by the autonomous traveling vehicle.

In the logistics system of US Patent Application Publication No. 2018/0137454, it may not be possible to carry the package to the delivery site when either a case in which the unmanned aerial vehicle is unable to fly from the distribution center to the relay point due to surrounding conditions, or a case in which in which the autonomous traveling vehicle is unable to travel from the relay point to the delivery site, has arisen.

### SUMMARY

In consideration of the above circumstances, an object of the present disclosure is to obtain a vehicle and delivery system that provides plural delivery methods in order to suppress cases in which a package cannot be delivered.

A vehicle of a first aspect includes a first hay configured to accommodate a ground-based moving body, a second bay configured to accommodate a flying moving body, a cargo hold connected to both the first bay and the second bay, and configured to store a package to be moved to either the ground-based moving body or the flying moving body, and a selection section configured to select whether to move the package in the cargo hold to the ground-based moving body or the flying moving body.

The vehicle of the first aspect accommodates the ground-based moving body and the flying moving body, and the package can be delivered by either the ground-based moving body or the flying moving body. The vehicle enables cases in which the package cannot be delivered to be suppressed.

A vehicle of a second aspect is the vehicle of the first aspect, wherein the vehicle is an autonomous vehicle. The vehicle includes a position acquisition section configured to acquire position information relating to the vehicle, an environment detection section capable of detecting travel environment information relating to surroundings of the vehicle, a travel plan creation section configured to create a travel plan, and a flight viability determination section configured to determine whether or not flight of the flying moving body is viable based on at least one of the position information, the travel environment information, or the travel plan.

In the vehicle of the second aspect, the vehicle position information, the travel environment information such as the weather, and the vehicle travel plan, which are required for autonomous driving, can be employed in the determination as to whether or not flight of the flying moving body is viable. In this vehicle, the viability of flight of the flying moving body is determined taking the environment around the vehicle into account, enabling the ground-based moving body to be utilized in a case in which flight is not viable.

A vehicle of a third aspect is the vehicle of the second aspect, wherein the flight viability determination section is further configured to determine whether or not flight of the flying moving body is viable based on attribute information relating to an attribute of the package.

In the vehicle of the third aspect, in addition to the environment around the vehicle, an attribute such as the size, shape, weight, contents of the package can be employed in the determination as to whether or not flight of the flying moving body is viable. In this vehicle, the viability of flight of the flying moving body is determined taking an attribute of the package and the environment around the vehicle into account, enabling delivery using the flying moving body to be optimized.

A vehicle of a fourth aspect is the vehicle of any one of the first to the third aspects, wherein the vehicle is an autonomous vehicle. The vehicle includes a position acquisition section configured to acquire position information relating to the vehicle, an environment detection section capable of detecting travel environment information relating to surroundings of the vehicle, a travel plan creation section configured to create a travel plan, and a movement viability determination section configured to determine whether or not movement of the ground-based moving body is viable based on delivery site information relating to a delivery site of the package, and at least one of the position information, the travel environment information, or the travel plan.

In the vehicle of the fourth aspect, in addition to the environment around the vehicle, the delivery site information, such as the state of a travel path and the elevation of the delivery site, can be employed in the determination as to whether or not movement of the ground-based moving body is viable. In this vehicle, the viability of movement of the ground-based moving body is determined taking the delivery site information and the environment around the vehicle into account, enabling delivery using the ground-based moving body to be optimized.

A vehicle of a fifth aspect is the vehicle of any one of the first to the fourth aspects, wherein the first bay is disposed at a vehicle lower side of the cargo hold, and the second bay is disposed further toward a vehicle upper side than the first bay.

In the vehicle of the fifth aspect, the ground-based moving body that descends onto the travel path from the vehicle is accommodated in the vehicle lower side of the vehicle, and the flying moving body that flies into the air above the vehicle is accommodated in the vehicle upper side of the vehicle. In this vehicle, each moving body can be provided with an in-vehicle space appropriate for its movement characteristics.

A vehicle of a sixth aspect is the vehicle of the fifth aspect, further including a sorting room that is disposed in the cargo hold so as to be adjacent to both the first bay and the second bay, and in which the package, when stored, is sorted for either the ground-based moving body or the flying moving body. The sorting room sorts by moving the package toward a vehicle lower side toward the ground-based moving body, or by sliding the package toward the flying moving body.

In the vehicle of the sixth aspect, packages are moved in different directions from the sorting room in order to move the packages to either the ground-based moving body or the flying moving body, thereby enabling more efficient sorting of the packages.

A delivery system of a seventh aspect includes the vehicle of any one of the first to the sixth aspects, the ground-based moving body, and the flying moving body. The vehicle includes a window in a wall of the second bay. The flying moving body includes a flight environment detection section capable of detecting flight environment information relating to surroundings of the flying moving body through the window, and a flight feasibility determination section configured to determine whether or not flight of the flying moving body is viable based on the flight environment information.

In the delivery system of the seventh aspect, the flight environment information such as the weather can be utilized in the determination as to whether or not flight of the flying moving body is viable. In this delivery system, the viability of flight of the flying moving body is determined taking the environment around the flying moving body into account, enabling the ground-based moving body to be utilized in a case in which flight is not viable.

A delivery system of an eighth aspect is the delivery system of the seventh aspect, wherein the flight feasibility determination section is further configured to determine whether or not flight of the flying moving body is viable based on attribute information relating to an attribute of the package.

In the delivery system of the eight aspect, in addition to the environment around the flying moving body, an attribute such as the size, shape, weight, contents of the package can be employed in the determination as to whether or not flight of the flying moving body is viable. In this delivery system, the viability of flight of the flying moving body is determined taking an attribute of the package and the environment around the flying moving body into account, enabling delivery using the flying moving body to be optimized.

A delivery system of a ninth aspect includes a ground-based moving body, a flying moving body, a vehicle configured to accommodate the ground-based moving body and the flying moving body and configured to store a package capable of being transferred to the ground-based moving body or the flying moving body, and a processing server capable of communicating with at least the vehicle. The processing server includes a status acquisition section configured to acquire, from the vehicle, movement viability information relating to the ground-based moving body and flight viability information relating to the flying moving body, a position information acquisition section configured to acquire position information relating to a position of the vehicle, and a notification section configured to notify a user corresponding to a delivery site of the package of arrival of the package in a case in which the movement viability information indicates that movement is not viable and the flight viability information indicates that flight is not viable, when the position of the vehicle is also proximate to the delivery site of the package.

In the delivery system of the ninth aspect, in a case in which delivery by the ground-based moving body and delivery by the flying moving body are not viable, the user can be prompted to come to the vehicle to collect the package. This delivery system provides the user with a package delivery means, even if movement of both moving bodies is not viable.

A delivery system of a tenth aspect is the delivery system of the ninth aspect, wherein the processing server includes a reward conferring section configured to confer a reward to the user enabling a product to be obtained in a case in which the user collects the package from the vehicle.

In the delivery system of the tenth aspect, the user can be provided with an incentive to come and collect the package, enabling the effort spent on redelivery to be lessened.

The present disclosure enables cases in which a package cannot be delivered to be suppressed by providing plural delivery methods.

### BRIEF DESCRIPTION OF THE DRAWINGS

Exemplary embodiments of the present disclosure will be described in detail based on the following figures, wherein:

FIG. 1 is a diagram illustrating a schematic configuration of a delivery system according to an exemplary embodiment;

FIG. 2A is a diagram to explain a delivery flow of a package in an exemplary embodiment;

FIG. 2B is a diagram to explain a delivery flow of a package in an exemplary embodiment;

FIG. 2C is a diagram to explain a delivery flow of a package in an exemplary embodiment;

FIG. 2D is a diagram to explain a delivery flow of a package in an exemplary embodiment;

FIG. 2E is a diagram to explain a delivery flow of a package in an exemplary embodiment;

FIG. 2F is a diagram to explain a delivery flow of a package in an exemplary embodiment;

FIG. 3 is a side cross-section to explain a structure of a vehicle;

FIG. 4 is a block diagram illustrating a hardware configuration of a vehicle controller;

FIG. 5 is a block diagram illustrating an example of functional configuration of a CPU of a vehicle controller of a first exemplary embodiment;

FIG. 6 is a side view to explain a structure of a traveling robot;

FIG. 7 is a block diagram illustrating a hardware configuration of a traveling robot controller;

FIG. 8 is a block diagram illustrating an example of functional configuration of a CPU of a traveling robot controller;

FIG. 9 is a side view to explain a structure of a drone;

FIG. 10 is a block diagram illustrating a hardware configuration of a drone controller;

FIG. 11 is a block diagram illustrating an example of functional configuration of a CPU of a drone controller of the first exemplary embodiment;

FIG. 12 is a block diagram illustrating a hardware configuration of a processing server;

FIG. 13 is a block diagram illustrating functional configuration of a CPU of a processing server;

FIG. 14 is a flowchart illustrating an example of a flow of sorting processing performed by a vehicle controller;

FIG. 15 is a flowchart illustrating an example of a flow of notification processing performed by a processing server;

FIG. 16 is a block diagram illustrating an example of functional configuration of a CPU of a drone controller of a second exemplary embodiment; and

FIG. 17 is a block diagram illustrating an example of functional configuration of a CPU of a vehicle controller of a third exemplary embodiment.

### DETAILED DESCRIPTION

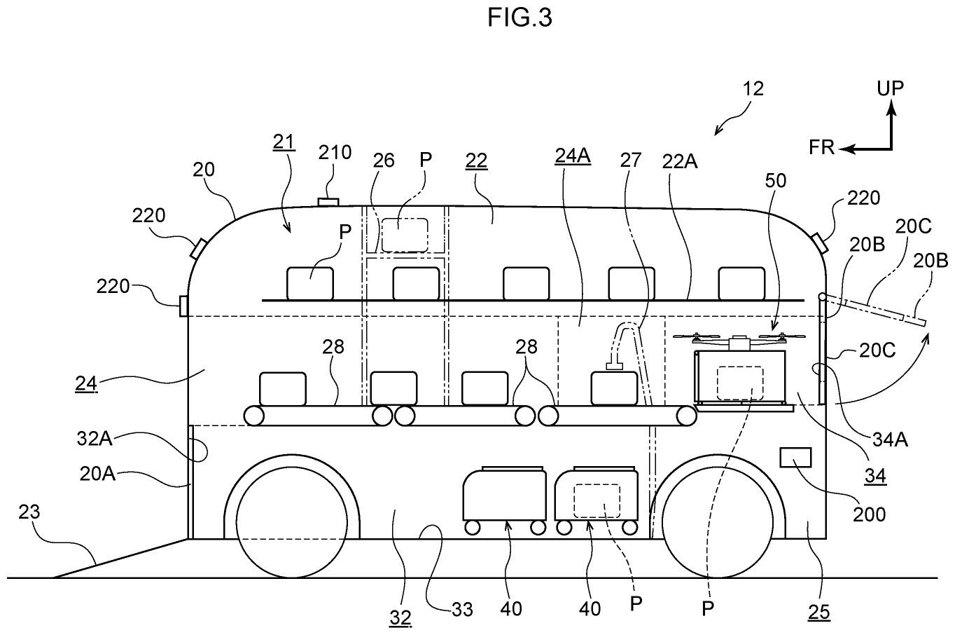

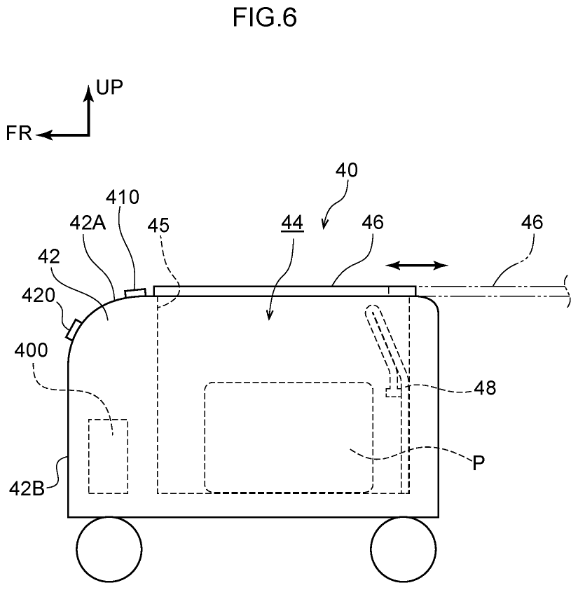

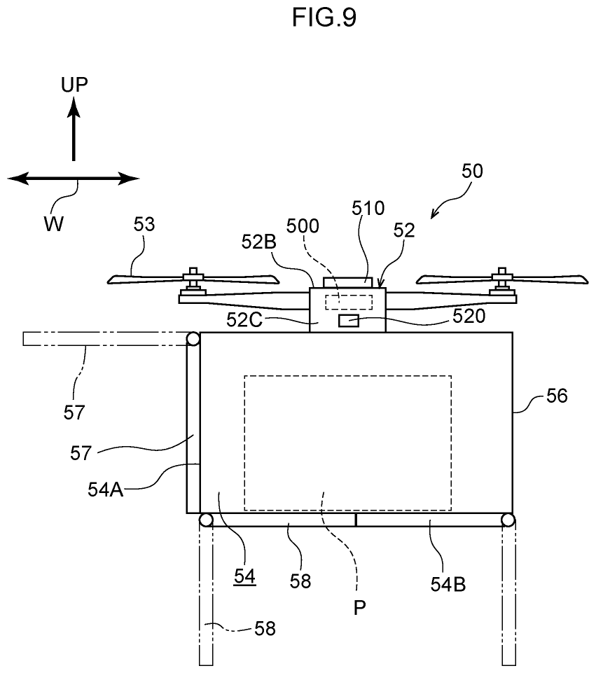

Explanation follows regarding a vehicle and a delivery system of exemplary embodiments of the present disclosure, with reference to the drawings. In FIG. 3 and FIG. 6, the arrow FR indicates a vehicle front, and the arrow UP indicates a vehicle upper side. In FIG. 9, the arrow UP indicates a body upper side, and the arrow W indicates a body width direction.

### First Exemplary Embodiment

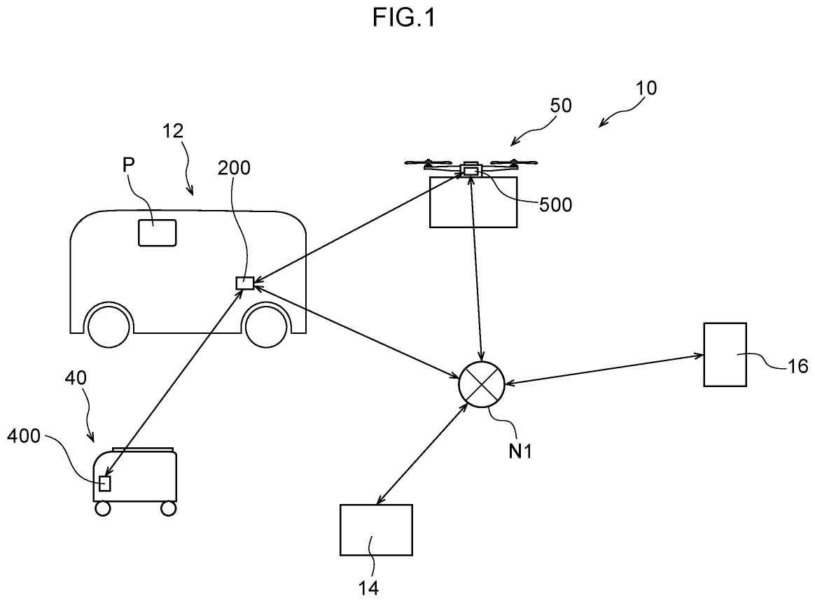

FIG. 1 is a block diagram illustrating a schematic configuration of a delivery system 10 according to a first exemplary embodiment.

Outline

As illustrated in FIG. 1, the delivery system 10 according to the present exemplary embodiment may include a vehicle 12, configuring an autonomous vehicle, a traveling robot 40, configuring a ground-based moving body, a drone 50, configuring a flying moving body, a processing server 14, and a smartphone 16 serving as a terminal. A package P for a specific user is stored in the vehicle 12 of the present exemplary embodiment. The vehicle 12 is also capable of carrying the traveling robot 40 and the drone 50 that deliver the package P.

In the present exemplary embodiment, the vehicle 12 includes a controller 200, the traveling robot 40 includes a controller 400, and the drone 50 includes a controller 500. In the delivery system 10, the controller 200 of the vehicle 12, the controller 400 of the traveling robot 40, the controller 500 of the drone 50, the processing server 14, and the smartphone 16 are connected together through a network N1. The controller 200 is also capable of communicating with the controller 400 and the controller 500 independently of the network N1.

Although only one of each of the vehicle 12, the traveling robot 40, the drone 50, and the smartphone 16 are provided for the single processing server 14 in the delivery system 10 illustrated in FIG. 1, there is no limitation thereto. In reality plural vehicles 12, traveling robots 40, drones 50, and smartphones 16 would be provided for a single processing server 14.

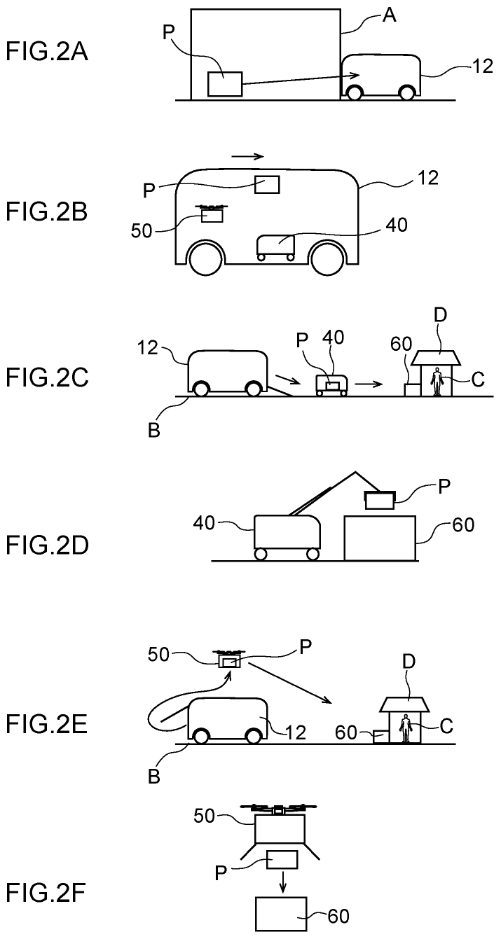

FIG. 2A to FIG. 2F illustrate a flow of delivery of the package P by the delivery system 10 of the present exemplary embodiment. The delivery system 10 of the present exemplary embodiment is used to deliver a product purchased by a specific user C on the internet or the like to where the user C resides. Specifically, the product purchased by the user C is stored in the vehicle 12 from a distribution center A as the package P (see FIG. 2A), and the vehicle 12 travels toward the delivery site D where the user C resides (see FIG. 2B). The package P is moved to the traveling robot 40 or the drone 50 in the vehicle 12 that has reached the vicinity of the delivery site D. When the vehicle 12 arrives at a destination B set in the vicinity of the delivery site D, in a case in which the package P has been housed in the traveling robot 40, the traveling robot 40 travels to the delivery site D (see FIG. 2C), and stores the package P in a delivery box 60 (see FIG. 2D). In a case in which the package P is stored in the drone 50, the drone 50 flies to the delivery site D (see FIG. 2E), and drops and stores the package P in the delivery box 60 (see FIG. 2F). Note that instead of storing the package P in the delivery box 60, the package P may be placed at a predetermined location, or the package P may be handed directly to the user C.

Vehicle

FIG. 3 is a side view cross-section illustrating the structure of the vehicle 12 of the present exemplary embodiment. As illustrated in FIG. 3, the vehicle 12 includes a substantially box shaped vehicle body 20 including a cabin 21 having three tiers in a vehicle vertical direction. A cargo hold 22 in which plural packages P are stored is provided at the upper tier of the cabin 21. A sorting room 24 in which packages P are sorted is provided at a vehicle front side of the middle tier of the cabin 21, and a drone bay 34, serving as a second bay for accommodating a single drone 50 is provided at the vehicle rear side of the middle tier of the cabin 21. The sorting room 24 is provided over a range corresponding to approximately three quarters of the total length of the vehicle 12, and the drone bay 34 is provided over a range corresponding to approximately one quarter of the total length of the vehicle 12. Note that a region adjoining the drone bay 34 at the vehicle rear side of the sorting room 24 configures a sorting operation area 24A in which a package P is sorted for either the traveling robot 40 or the drone 50.

A vehicle bay 32, serving as a first bay for accommodating plural traveling robots 40, is provided at the vehicle front side of the lower tier of the cabin 21, and a unit compartment 25 is provided at the vehicle rear side of the lower tier of the cabin 21. The vehicle bay 32 is provided at the vehicle lower side of the sorting room 24. The unit compartment 25 is provided at the vehicle lower side of the drone bay 34. A drive device of the vehicle 12, a control unit relating to autonomous driving, and the controller 200 relating to package P delivery are housed in the unit compartment 25. A GPS (Global Positioning System) device 210 is provided at an upper section of the vehicle body 20, and plural environmental sensors 220 are provided at the vehicle front and vehicle rear of the vehicle body 20.

A door opening 32A at the vehicle front side of the vehicle bay 32 is provided with a sliding door 20A, supported so as to be capable of opening and closing by sliding in the vehicle width direction. A ramp 23 is also provided, on which the traveling robots 40 are able to travel from a vehicle front side end portion of a floor 33 of the vehicle bay 32 to a road surface. The ramp 23 is capable of being stowed below the floor 33. In the present exemplary embodiment, when the sliding door 20A opens, a traveling robot 40 is able to pass through the door opening 32A and descend the ramp 23 to move out onto a travel path. The sliding door 20A is opened and closed automatically by a mover mechanism, and the ramp 23 is capable of moving accompanying the opening and closing operation of the sliding door 20A by the mover mechanism. Note that instead of the sliding door 20A, a door supported at a vehicle lower side end portion may be provided such that a vehicle upper side of the door is capable of pivoting with respect to the door opening 32A, this door being opened until an upper end side of the door contacts the road surface such that an inside face of the door is used as the ramp.

A door opening 34A at the vehicle rear side of the drone bay 34 is provided with a hinged door 20B supported at a vehicle upper side end portion such that a vehicle lower side of the hinged door 20B is capable of pivoting. In the present exemplary embodiment, when the hinged door 20B is opened, the drone 50 is able to pass through the door opening 34A and fly out of the vehicle. In an open state of the hinged door 20B, the hinged door 20B projects from an upper side edge of the door opening 34A toward the rear to form a roof cave. The hinged door 20B is opened and closed automatically by a non-illustrated opening and closing mechanism. Note that instead of the hinged door 20B, a sliding door that is supported so as to be capable of opening and closing by sliding with respect to the door opening 34A may be provided. A window 20C is formed in a vehicle width direction and vehicle vertical direction central portion of the hinged door 20B.

A passage extending along the vehicle front-rear direction and the vehicle vertical direction is provided at the vehicle width direction center of the cargo hold 22. Racks 22A on which packages P are placed are provided on both vehicle width direction sides of the passage. The passage is provided with a stacker crane 26 to move the packages P in the cargo hold 22 upward, downward, and toward the front and rear, and to move the packages P into the sorting room 24. Conveyors 28 are provided to a floor spanning from the sorting room 24 including the sorting operation area 24A to the drone bay 34 in order to move packages P toward the front and rear. A robotic arm 27 is provided spanning from the sorting operation area 24A to the vehicle bay 32.

In the present exemplary embodiment, when a specific package P is to be delivered, first, the package P is taken from the racks 22A in the cargo hold 22 and placed on the corresponding conveyor 28 in the sorting room 24 by the stacker crane 26. In the sorting room 24, the one package P is moved from amongst plural packages P into the sorting operation area 24A by the conveyors 28. In the sorting operation area 24A, the package P is moved into the drone bay 34 or the vehicle bay 32 by sorting processing, described later.

In a case in which the package P is moved into the drone bay 34, the package P is stored in a storage compartment 54 of the drone 50, described later, by the corresponding conveyor 28. In a case in which the package P is moved into the vehicle bay 32, the package P is stored in a storage compartment 44 of the traveling robot 40, described later, by the robotic arm 27.

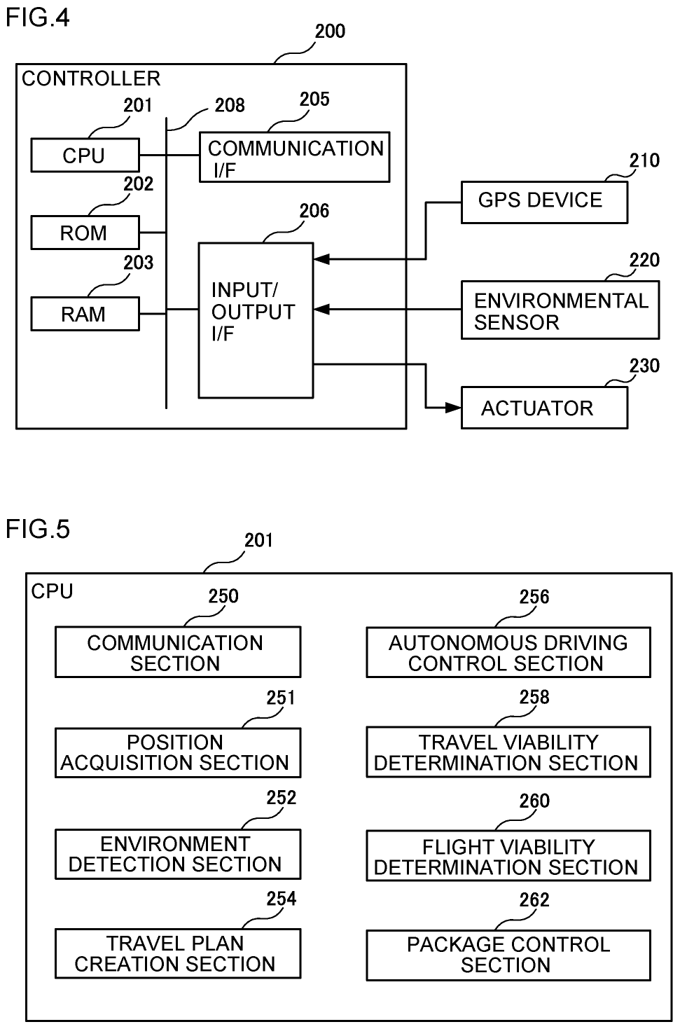

FIG. 4 is a block diagram illustrating a hardware configuration of devices installed to the vehicle 12 of the present exemplary embodiment. In addition to the controller 200 described above, the vehicle 12 includes the GPS device 210 that acquires the current position of the vehicle 12, the environmental sensors 220 that detect the environment around the vehicle 12, and an actuator 230 that performs acceleration, deceleration, and steering of the vehicle 12. Note that the environmental sensors 220 are configured including cameras that image a predetermined range, millimeter wave radar that transmits exploratory waves in a predetermined range, and LIDAR (Light. Detection and Ranging/Laser Imaging Detection and Ranging) that scans a predetermined range.

The controller 200 is configured including a Central Processing Unit (CPU) 201, Read Only Memory (ROM) 202, Random Access Memory (RAM) 203, a communication interface (I/F) 205, and an input/output I/F 206. The CPU 201, the ROM 202, the RAM 203, the communication I/F 205, and the input/output 1/F 206 are connected through a bus 208 so as to be capable of communicating with each other. The CPU 201 corresponds to a first processor, and the RAM 203 corresponds to a first memory.

The CPU 201 is a central processing unit that executes various programs and controls the respective sections. Namely, the CPU 201 reads a program from the ROM 202, and executes the program employing the RAM 203 as a workspace. In the present exemplary embodiment, an execution program is stored in the ROM 202. By executing the execution program, the CPU 201 functions as a communication section 250, a position acquisition section 251, an environment detection section 252, a travel plan creation section 254, an autonomous driving control section 256, a travel viability determination section 258, a flight viability determination section 260, and a package control section 262, all illustrated in FIG. 5.

The ROM 202 stores various programs and various data. The RAM 203 functions as a workspace in which programs and data are temporarily stored.

The communication I/F 205 is an interface for communication with the controllers 400, 500, the processing server 14, and the like. For example, the communication I/F 205 employs a communication standard such as Long Term Evolution (LTE) or Wi-Fi (registered trademark).

The input/output 206 is an interface for communication with the respective devices installed to the vehicle 12. In the present exemplary embodiment, the GPS device 210, the environmental sensors 220, and the actuator 230 are connected to the controller 200 through the input/output I/F 206. The GPS device 210, the environmental sensors 220, and the actuator 230 may be directly connected to the bus 208.

FIG. 5 is a block diagram illustrating an example of a functional configuration of the CPU 201. As illustrated in FIG. 5, the CPU 201 includes the communication section 250, the position acquisition section 251, the environment detection section 252, the travel plan creation section 254, the autonomous driving control section 256, the travel viability determination section 258, the flight viability determination section 260, and the package control section 262. Each functional configuration is implemented by the CPU 201 reading and executing the execution program stored in the ROM 202.

The communication section 250 has a function of transmitting and receiving various information via the communication I/F 205.

The position acquisition section 251 has a function of acquiring a current position of the vehicle 12. The position acquisition section 251 acquires position information from the GPS device 210 via the input/output I/F 206.

The environment detection section 252 has a function of detecting the travel environment around the vehicle 12. The environment detection section 252 acquires the travel environment of the vehicle 12 from the environmental sensors 220 via the input/output I/F 206 as travel environment information. The “travel environment information” includes the weather, brightness, travel path width, obstacles, and the like around the vehicle 12.

The travel plan creation section 254 has a function of creating a travel plan for the vehicle 12 from the distribution center A to one or plural destinations B and back to the distribution center A.

The autonomous driving control section 256 has a function of making the vehicle 12 travel by actuating the actuator 230 according to the created travel plan while taking the position information and the travel environment information into account.

The travel viability determination section 258, serving as a movement viability determination section, has a function of performing a travel viability determination as to whether or not travel (movement) of the traveling robot 40 is viable. Specifically, the travel viability determination section 258 determines whether or not travel of the traveling robot 40 is viable based on at least one of the position information of the vehicle 12, the surrounding travel environment information, or the travel plan. The “travel environment information” is as described above. The travel viability determination section 258 may also employ delivery site information relating to the delivery site D of the package P in the travel viability determination in addition to the position information, travel environment information, and travel plan. The “delivery site information” includes the state of a travel path to the delivery site D (for example, paved road, dirt road, or the like), and the elevation of the delivery site D (for example, on the same level as the travel path, on an upper floor, or the like). The delivery site information may be acquired from the processing server 14.

The flight viability determination section 260 has a function of performing a flight viability determination as to whether or not flight of the drone 50 is viable. Specifically, the flight viability determination section 260 determines whether or not flight of the drone 50 is viable based on at least one of the position information of the vehicle 12, the surrounding travel environment information, or the travel plan. The “travel environment information” is as described above. The flight viability determination section 260 may also employ attribute information relating to attributes of the package P in the flight viability determination in addition to the position information, travel environment information, and travel plan. The “attribute information” includes the size, shape, weight, contents, and the like of the package P. The attribute information may be acquired from a barcode or a two-dimensional code such as a QR code (registered trademark) displayed on the package P, or may be acquired from the processing server 14.

The package control section 262, serving as a selection section, has a function of selecting the moving body in which to store the package P, moving the package P to the selected moving body, and launching the moving body. First, the package control section 262 selects either the traveling robot 40 or the drone 50 as a movement destination for the package P, based on the travel viability information (movement viability information) relating to the viability of travel (movement) of the traveling robot 40, and the flight viability information relating to the viability of flight of the drone 50. The package control section 262 moves the package in the cargo hold 22 to the drone 50 in preference to the traveling robot 40 in a case in which movement of the traveling robot 40 is viable and flight of the drone 50 is also viable. The package control section 262 then moves the selected package P in the sorting operation area 24A to the drone 50 in the drone bay 34, or to the traveling robot 40 in the vehicle bay 32. The package control section 262 then opens the sliding door 20A and draws out the ramp 23 toward the road surface in order to launch the traveling robot 40 in which the package P has been stored. Alternatively, the package control section 262 opens the hinged door 20B in order to launch the drone 50 in which the package P is stored.

Traveling Robot

In the present exemplary embodiment, an unmanned traveling robot is applied as the ground-based moving body. FIG. 6 is a side view illustrating the structure of the traveling robot 40 of the present exemplary embodiment. As illustrated in FIG. 6, the traveling robot 40 is configured including a substantially box shaped vehicle body 42, the storage compartment 44 inside the vehicle body 42 in which the package P is stored, and a cover 46 that closes off an opening 45 in an upper portion of the storage compartment 44.

The cover 46 is supported so as to be capable of moving in a vehicle front-rear direction along rails provided on both vehicle width direction sides of the opening 45. The cover 46 moves toward the vehicle rear from an upper portion of the opening 45 so as to open up the opening 45. The traveling robot 40 further includes a robotic arm 48 to move the package P from the storage compartment 44 to the vehicle exterior.

A GPS device 410 is provided to an upper portion 42A of the vehicle body 42, and an environmental sensor 420 is provided to at least a side portion 42B at the vehicle front. The controller 400, serving as a travel control section, is provided inside the vehicle body 42. The environmental sensor 420 includes a camera, millimeter wave radar, and LIDAR, similarly to the environmental sensors 220 provided to the vehicle 12.

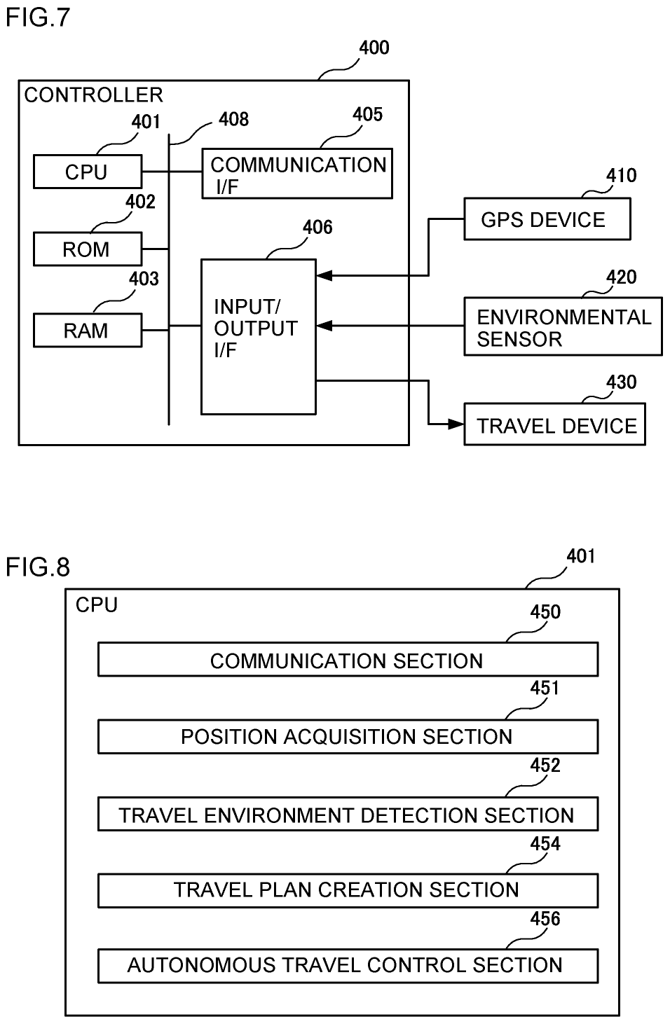

FIG. 7 is a block diagram illustrating a hardware configuration of the traveling robot 40 of the present exemplary embodiment. In addition to the controller 400 described above, the traveling robot 40 also includes the GPS device 410 that acquires a current position of the traveling robot 40, the environmental sensor 420 that detects the environment around the traveling robot 40, and a travel device 430 that performs acceleration, deceleration, and steering of the traveling robot 40.

The controller 400 is configured including a CPU 401, ROM 402, RAM 403, a communication I/F 405, and an input/output I/F 406. The CPU 401, the ROM 402, the RAM 403, the communication I/F 405, and the input/output I/F 406 are connected through a bus 408 so as to be capable of communicating with each other. Functionality of the CPU 401, the ROM 402, the RAM 403, the communication I/F 405, and the input/output I/F 406 is the same as that of the CPU 201, the ROM 202, the RAM 203, the communication I/F 205, and the input/output 11F 206 of the controller 200 described above.

The CPU 401 reads a program from the ROM 402, and executes the program employing the RAM 403 as a workspace. In the present exemplary embodiment, an execution program is stored in the ROM 402. By executing the execution program, the CPU 401 functions as a communication section 450, a position acquisition section 451, a travel environment detection section 452, a travel plan creation section 454, and an autonomous travel control section 456, all illustrated in FIG. 8.

The GPS device 410, the environmental sensor 420, and the travel device 430 are connected to the controller 400 of the present exemplary embodiment via the input/output I/F 406. Note that the GPS device 410, the environmental sensor 420, and the travel device 430 may be connected directly to the bus 408.

FIG. 8 is a block diagram illustrating an example of functional configuration of the CPU 401. As illustrated in FIG. 8, the CPU 401 includes the communication section 450, the position acquisition section 451, the travel environment detection section 452, the travel plan creation section 454, and the autonomous travel control section 456. Each functional configuration is implemented by the CPU 401 reading and executing the execution program stored in the ROM 402.

The communication section 450 has a function of transmitting and receiving various information via the communication 405.

The position acquisition section 451 has a function of acquiring the current position of the traveling robot 40. The position acquisition section 451 acquires position information from the GPS device 410 via the input/output I/F 406.

The travel environment detection section 452 has a function of detecting the travel environment around the traveling robot 40. The travel environment detection section 452 acquires the travel environment of the traveling robot 40 from the environmental sensor 420 via the input/output I/F 406 as travel environment information. The “travel environment information” includes the weather, brightness, travel path width, obstacles, and the like, similarly to the travel environment information of the vehicle 12.

The travel plan creation section 454 has a function of creating a travel plan for the traveling robot 40 from the vehicle 12 to the delivery site D corresponding to the user C (the delivery box 60 in FIG. 2C) and back to the vehicle 12.

The autonomous travel control section 456 has a function of making the traveling robot 40 travel by operating the travel device 430 according to the created travel plan while taking the travel environment into account. The autonomous travel control section 456 also has a function of discharging the package P by operation of the robotic arm 48.

Drone

In the present exemplary embodiment, a drone configured by an unmanned multicopter is applied as the flying moving body. FIG. 9 is a side view illustrating the structure of the drone 50 of the present exemplary embodiment. As illustrated in FIG. 9, the drone 50 is configured including a drone body 52 provided with plural propellers 53, and a conveyance case 56 fixed to a lower end of the drone body 52.

The drone body 52 is substantially box shaped. An upper section 52B of the drone body 52 is provided with a GPS device 510, and at least a body front side section 52C of the drone body 52 is provided with an environmental sensor 520 that detects the environment around the drone 50. The controller 500, serving as a flight control section, is provided inside the drone body 52.

The conveyance case 56 is a rectangular parallelepiped box, and the inside of the conveyance case 56 configures the storage compartment 54 in which the package P is stored. One side wall 54A of the conveyance case 56 configures an opening and closing door 57 that pivots toward the body upper side. A bottom portion 54B of the conveyance case 56 configures an opening door 58, this being a double door that pivots toward the body lower side.

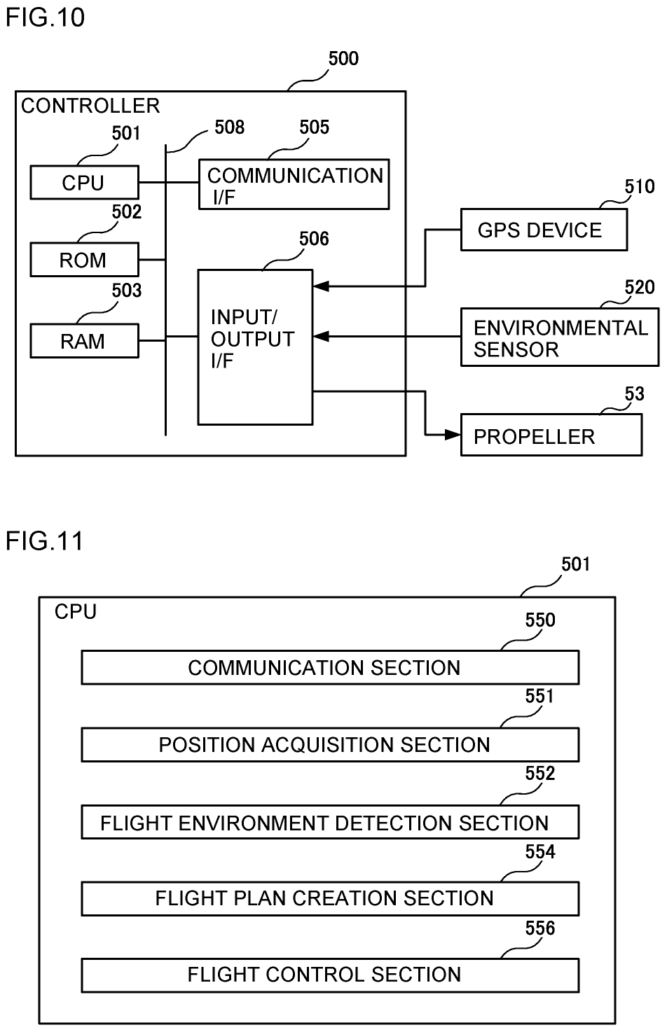

FIG. 10 is a block diagram illustrating a hardware configuration of the drone 50 of the present exemplary embodiment. In addition to the controller 500 described above, the drone 50 includes the GPS device 510 that acquires the current position of the drone 50, and the environmental sensor 520 that detects the environment around the drone 50. The environmental sensor 520 is configured including an ultrasound sensor, a gyro sensor, an air pressure sensor, a compass, and the like.

The controller 500 is configured including a CPU 501, ROM 502, RAM 503, a communication I/F 505, and an input/output I/F 506. The CPU 501, the ROM 502, the RAM 503, the communication IX 505, and the input/output I/F 506 are connected together through a bus 508 so as to be capable of communicating with each other. Functionality of the CPU 501, the ROM 502, the RAM 503, the communication I/F 505, and the input/output I/F 506 is similar to that of the CPU 201, the ROM 202, the RAM 203, the communication I/F 205, and the input/output I/F 206 of the controller 200 described above. The CPU 501 corresponds to a second processor, and the RAM 503 corresponds to a second memory.

The CPU 501 reads a program from the ROM 502, and executes the program employing the RAM 503 as a workspace. In the present exemplary embodiment, an execution program is stored in the ROM 502. By executing the execution program, the CPU 501 functions as a communication section 550, a position acquisition section 551, a flight environment detection section 552, a flight plan creation section 554, and a flight control section 556, all illustrated in FIG. 11.

The GPS device 510, the environmental sensor 520, and the propellers 53 are connected to the controller 500 of the present exemplary embodiment via the input/output I/F 506. Note that the GPS device 510, the environmental sensor 520, and the propellers 53 may be directly connected to the bus 508.

FIG. 11 is a block diagram illustrating an example of functional configuration of the CPU 501. As illustrated in FIG. 11, the CPU 501 includes the communication section 550, the position acquisition section 551, the flight environment detection section 552, the flight plan creation section 554, and the flight control section 556. Each functional configuration is implemented by the CPU 501 reading and executing the execution program stored in the ROM 502.

The communication section 550 has a function of transmitting and receiving various information via the communication I/F 505.

The position acquisition section 551 has a function of acquiring a current position of the drone 50. The position acquisition section 551 acquires position information from the GPS device 510 via the input/output I/F 506.

The flight environment detection section 552 has a function of detecting a flight environment around the drone 50. The flight environment detection section 552 acquires the flight environment of the drone 50 from the environmental sensor 520 via the input/output I/F 506 as flight environment information. Note that the “flight environment information” includes the weather, brightness, obstacles, and the like around the drone 50.

The flight plan creation section 554 has a function of creating a flight plan from the vehicle 12 to the delivery site D corresponding to the user C (the delivery box 60 in FIG. 2E) and back to the vehicle 12.

The flight control section 556 has a function of making the drone 50 fly by operating the propellers 53 according to the created flight plan while taking the flight environment into account. The flight control section 556 also has a function of dropping the package P by opening up the opening door 58.

Processing Server

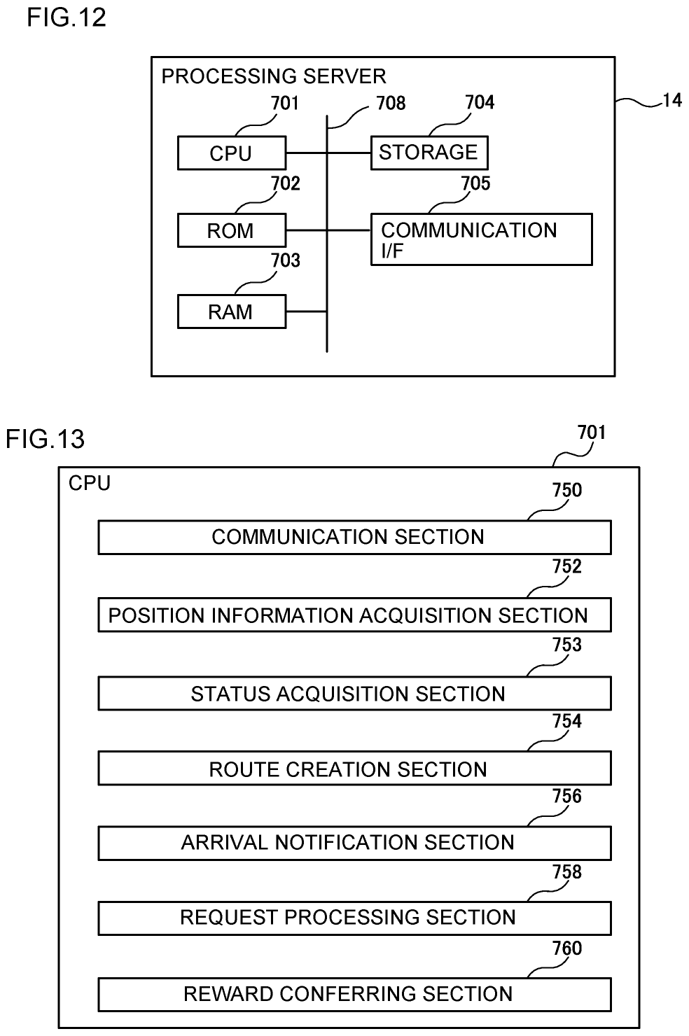

As illustrated in FIG. 12, the processing server 14 is configured including a CPU 701, ROM 702, RAM 703, storage 704, and a communication 1/F 705. The CPU 701, the ROM 702, the RAM 703, the storage 704, and the communication I/F 705 are connected through a bus 708 so as to be capable of communicating with each other. The functionality of the CPU 701, the ROM 702, the RAM 703, and the communication I/F 705 is similar to that of the CPU 201, the ROM 202, the RAM 203, and the communication I/F 205 of the controller 200 described above. The CPU 701 corresponds to a third processor, and the RAM 703 corresponds to a third memory.

The CPU 701 reads a program from the ROM 702 or the storage 704, and executes the program employing the RAM 703 as a workspace. In the present exemplary embodiment, a processing program is stored in the storage 704. By executing the processing program, the CPU 701 functions as a communication section 750, a position information acquisition section 752, a status acquisition section 753, a route creation section 754, an arrival notification section 756, a request processing section 758, and a reward conferring section 760, all illustrated in FIG. 13.

The storage 704, serving as a storage section, is configured by a Hard Disk Drive (HDD) or a Solid State Drive (SSD), and stores various programs, including an operating system, and various data.

FIG. 13 is a block diagram illustrating an example of functional configuration of the CPU 701. As illustrated in FIG. 13, the CPU 701 includes the communication section 750, the position information acquisition section 752, the status acquisition section 753, the route creation section 754, the arrival notification section 756, the request processing section 758, and the reward conferring section 760. Each functional configuration is implemented by the CPU 701 reading and executing the processing program stored in the storage 704.

The communication section 750 has a function of transmitting and receiving various information via the communication I/F 705.

The position information acquisition section 752 has a function of acquiring position information of the vehicle 12, the traveling robot 40, and the drone 50 via the communication I/F 705.

The status acquisition section 753 has a function of acquiring the travel viability information relating to the viability of travel of the traveling robot 40 and the flight viability information relating to the viability of flight of the drone 50 from the vehicle 12 which the traveling robot 40 and the drone 50 are onboard. More specifically, the status acquisition section 753 acquires the travel viability information and the flight viability information from the controller 200 via the communication I/F 705.

The route creation section 754 has a function of creating a travel plan for the vehicle 12. Note that the route creation section 754 may also create a travel plan for the traveling robot 40 or a flight plan for the drone 50. In such cases, the travel plan for the traveling robot 40 is transmitted from the processing server 14 to the controller 400 of the traveling robot 40 either directly or via the controller 200 of the vehicle 12. The flight plan for the drone 50 is transmitted from the processing server 14 to the controller 500 of the drone 50 either directly or via the controller 200 of the vehicle 12.

The arrival notification section 756, serving as a notification section, has a function of notifying the user C of the arrival of the package P. Specifically, the arrival notification section 756 transmits arrival information indicating that the package P is to arrive to the smartphone 16 of the user C via the communication I/F 705 when the vehicle 12 is proximate to the destination B set in the vicinity of the delivery site D according to the travel plan for the vehicle 12.

The request processing section 758 has a function of notifying the vehicle 12 that the user C has approved acceptance of the package P. Specifically, the request processing section 758 receives information indicating that the user C has approved acceptance of the package P from the smartphone 16 via the communication I/F 705, and transmits approval information indicating that the user C has approved acceptance of the package P to the controller 200 of the vehicle 12

The reward conferring section 760 has a function of conferring points, serving as a reward, to the user C. Specifically, the reward conferring section 760 confers points in a case in which the user C has come to collect the package P directly from the vehicle 12 without a delivery of the package P being made using the traveling robot 40 or the drone 50. The points may include points that can be converted into cash, points that can be used to discount the purchase cost when shopping, points that can be exchanged for goods, or the like. The conferred points are incremented to point amount data corresponding to an account belonging to the user C. The amount data may be stored by the processing server 14, or may be stored by the smartphone 16 or another external server.

Flow of Processing

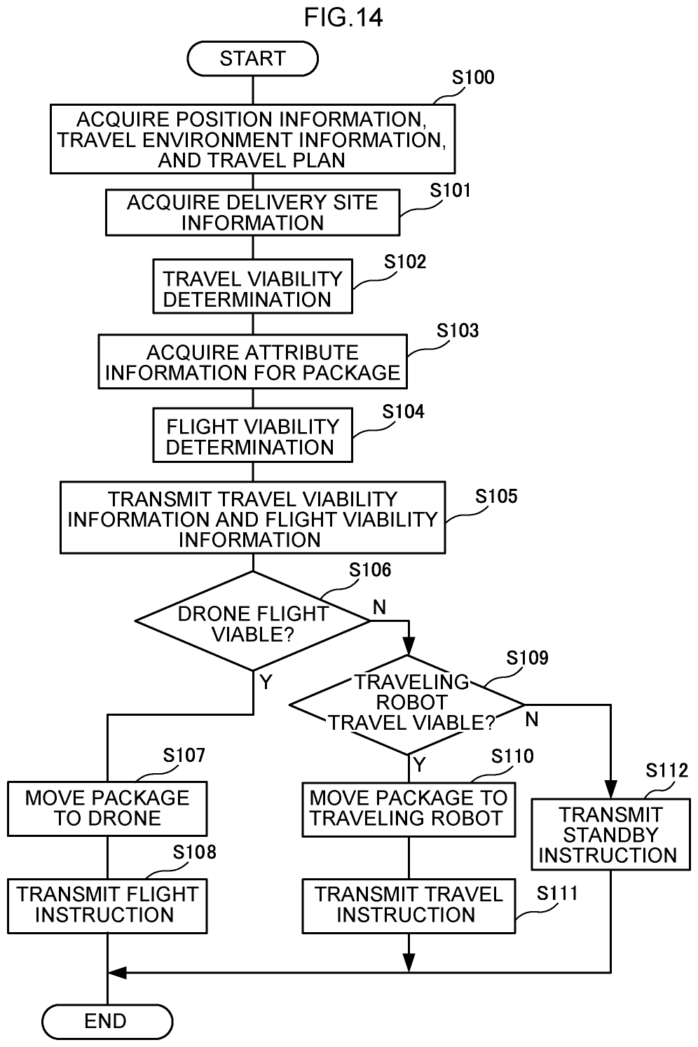

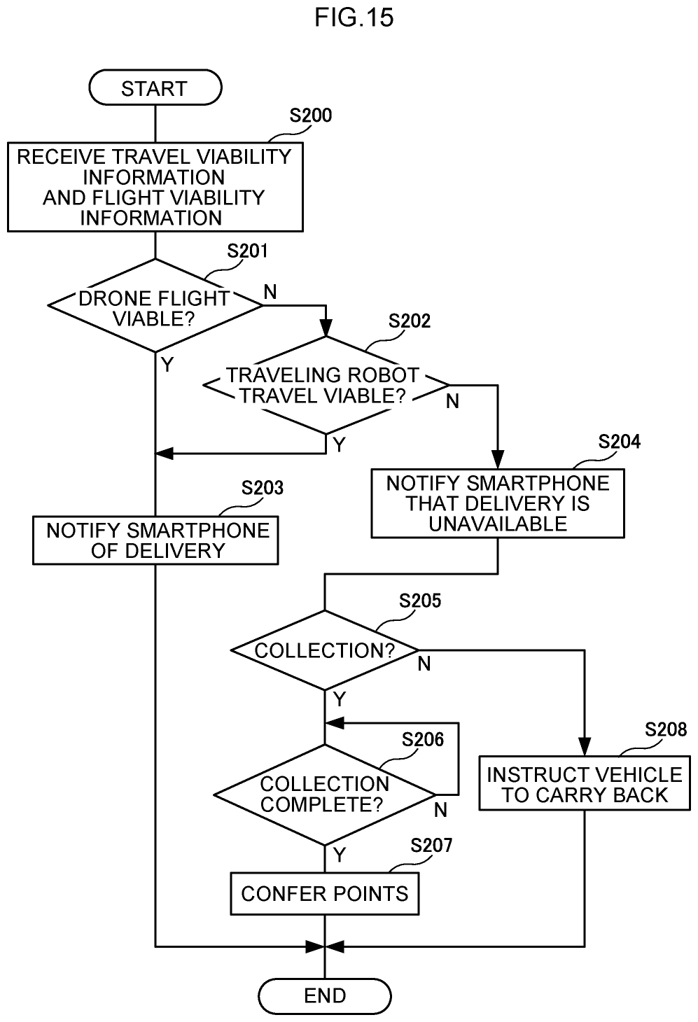

Next, explanation follows regarding a flow of processing in the delivery system 10 of the present exemplary embodiment, with reference to the flowcharts of FIG. 14 and FIG. 15.

As described above, the vehicle 12 in which the package P to be delivered to the user C is stored travels toward the destination B (see FIG. 2A).

Next, explanation follows regarding sorting processing executed by the controller 200 of the vehicle 12 as the vehicle 12 gets proximate to the destination B.

At step S100 in FIG. 14, the CPU 201 acquires the position information of the vehicle 12, the travel environment information, and the travel plan. The position information, the travel environment information, and the travel plan is information required for autonomous driving of the vehicle 12. Processing then proceeds to step S101.

At step S101, the CPU 201 acquires the delivery site information corresponding to the delivery site D for the package P from the processing server 14. Specifically, as the delivery site information, the CPU 201 acquires the state of the travel path to the delivery site D (for example paved road, dirt road, or the like) and the elevation of the delivery site D (for example on the same level as the travel path, on an upper floor, or the like). Processing then proceeds to step S102.

At step S102, the CPU 201 performs travel viability determination for the traveling robot 40. Specifically, the CPU 201 performs travel viability determination as to whether or not travel of the traveling robot 40 is viable based on the acquired position information, travel environment information and travel plan, and the delivery site information. For example, in cases in which an obstacle that the traveling robot 40 would not be able to pass can be detected on the travel path from the travel environment information, the CPU 201 determines that travel (movement) is not viable. Alternatively, for example, in cases in which it can be detected from the delivery site information that the delivery site D is on a balcony on the fifth floor of an apartment building, the CPU 201 determines that travel (movement) is not viable. In a case in which there is nothing to impede travel of the traveling robot 40, the CPU 201 determines that travel (movement) is viable. When the travel viability determination ends, processing proceeds to step S103.

At step S103, the CPU 201 acquires attribute information for the package P. Specifically, the CPU 201 acquires information relating to the size, weight, and shape of the package P based on two-dimensional code information imaged by a camera installed in the sorting room 24. Processing then proceeds to step S104.

At step S104, the CPU 201 performs flight viability determination for the drone 50. Specifically, the CPU 201 performs flight viability determination as to whether or not flight of the drone 50 is viable based on the acquired position information, travel environment information and travel plan, and the attribute information. For example, in a case in which it can be detected from the position information that the drone 50 is in a no-fly area, the CPU 201 determines that flight is not viable. Alternatively, for example, based on the attribute information, in a case in which the package P has a size or shape that would not fit in the storage compartment 54, in a case in which the weight of the package P exceeds a viable flying weight of the drone 50, or in a case in which the package P is vulnerable to changes in air pressure, the CPU 201 determines that flight is not viable. In a case in which there is nothing to impede flight of the drone 50, the CPU 201 determines that flight is viable. When the flight viability determination ends, processing proceeds to step S105.

At step S105, the CPU 201 transmits travel viability information as to whether travel is viable or not viable, as well as flight viability information as to whether flight is viable or not viable, to the processing server 14. Processing then proceeds to step S106.

At step S1.06, the CPU 201 determines whether or not flight of the drone 50 is viable. In a case in which the CPU 201 determines that flight of the drone 50 is viable based on the flight viability information, processing proceeds to step S107. In a case in which the CPU 201 determines that flight of the drone 50 is not viable, namely that flight is not possible based on the flight viability information, processing proceeds to step S109.

At step S107, the CPU 201 moves the package P to the drone 50. Specifically, the CPU 201 operates the corresponding conveyor 28 of the sorting operation area 24A to store the package P in the storage compartment 54 of the drone 50. Processing then proceeds to step S108.

At step S108, the CPU 201 transmits a flight instruction to the drone 50 in a case in which approval information indicating that the user C has approved acceptance of the package P has been received from the processing server 14. On receipt of the flight instruction, the drone 50 starts flying toward the delivery site D. The sorting processing is then ended.

At step S109, the CPU 201 determines whether or not travel of the traveling robot 40 is viable. In a case in which the CPU 201 determines that travel of the traveling robot 40 is viable based on the travel viability information, processing proceeds to step S110. In a case in which the CPU 201 determines that travel of the traveling robot 40 is not viable, namely that travel is not possible based on the travel viability information, processing proceeds to step 5112.

At step S110, the CPU 201 moves the package P to the traveling robot 40. Specifically, the CPU 201 operates the robotic aim 27 in the sorting operation area 24A to store the package P in the storage compartment 44 of the traveling robot 40. Processing then proceeds to step S111.

At step S111, the CPU 201 transmits a travel instruction to the traveling robot 40 in a case in which approval information indicating that the user C has approved acceptance of the package P has been received from the processing server 14. On receipt of the travel instruction, the traveling robot 40 starts traveling toward the delivery site D. The sorting processing is then ended.

At step S112, the CPU 201 transmits a standby instruction to the traveling robot 40 and the drone 50. On receipt of the standby instruction, the traveling robot 40 and the drone 50 stand by for further instructions from the CPU 201. The sorting processing is then ended.

Next, explanation follows regarding notification processing in the processing server 14 regarding delivery of the package P.

At step S200 in FIG. 15, the CPU 701 receives the travel viability information and the flight viability information from the controller 200 of the vehicle 12. Processing then proceeds to step S201.

At step S201, the CPU 701 determines whether or not flight of the drone 50 is viable. In a case in which the CPU 701 determines that flight of the drone 50 is viable based on the flight viability information, processing proceeds to step S203. In a case in which the CPU 701 determines that flight of the drone 50 is not viable, namely that flight is not viable based on the flight viability information, processing proceeds to step S202.

At step S202, the CPU 701 determines whether or not travel of the traveling robot 40 is viable. In a case in which the CPU 701 determines that travel of the traveling robot 40 is viable based on the travel viability information, processing proceeds to step S203. In a case in which the CPU 701 determines that travel of the traveling robot 40 is not viable, namely that travel is not viable based on the travel viability information, processing proceeds to step S204.

At step S203, the CPU 701 makes a delivery notification to the smartphone 16 of the user C. The delivery notification may be information notifying not only of delivery, but also of the arrival time and the like. The notification processing is then ended.

At step S204, the CPU 701 performs delivery unavailable notification to the smartphone 16 of the user C. The delivery unavailable notification may notify not only that delivery is not possible, but also suggest that the user C comes to the vehicle 12 to collect the package P, or notify of information to confirm a desired redelivery time. Processing then proceeds to step S205. Note that information to suggest collection and information to confirm the desired redelivery may be transmitted to the smartphone 16, and information relating to whether the package P is to be collected or redelivered may be acquired from the smartphone 16.

At step S205, the CPU 701 determines whether or not the user C will come to the vehicle 12 to collect the package P. In a case in which the CPU 701 determines that the package P will be collected based on information received from the smartphone 16, processing proceeds to step S206. In a case in which the CPU 701 determines that the package P will not be collected based on information received from the smartphone 16, processing proceeds to step S208.

At step S206, the CPU 701 determines whether or not collection of the package P by the user C is complete. In a case in which the CPU 701 determines that collection of the package P is complete, processing proceeds to step S207. In a case in which the CPU 701 determines that collection of the package P is not yet complete, step S206 is repeated.

At step S207, the CPU 701 confers predetermined points to the user C. The notification processing is then ended.

At step S208, the CPU 701 sends the controller 200 of the vehicle 12 a carry-back instruction to carry back the package P. On receipt of this instruction, the vehicle 12 returns to the distribution center A with the package P still stored therein. The notification processing is then ended.

### SUMMARY

In the delivery system 10 of the present exemplary embodiment, the vehicle 12 accommodates the traveling robot 40 and the drone 50 in the cabin 21, and is capable of transferring the package P to the traveling robot 40 or the drone 50. in the present exemplary embodiment, selection is made to load the package P into either the traveling robot 40 or the drone 50 in the sorting processing described above. By providing plural delivery methods, the vehicle 12 of the present exemplary embodiment is capable of suppressing cases in which packages cannot be delivered.

Note that in the sorting processing in the vehicle 12, the position information of the vehicle, the travel environment information such as weather information, and the vehicle travel plan, which are required for autonomous driving, can he employed in the flight viability determination as to whether or not flight of the drone 50 is viable. In the present exemplary embodiment, the viability of flight of the drone 50 is determined taking the environment around the vehicle 12 into account. The sorting processing enables the traveling robot 40 to be utilized in a case in which flight of the drone 50 is not viable.

In the sorting processing of the present exemplary embodiment, in addition to the environment around the vehicle 12, the attributes such as the size, shape, weight, contents of the package P can be employed in the flight viability determination for the drone 50. In the present exemplary embodiment, the viability of flight of the drone 50 is determined taking the attributes of the package P and the environment around the vehicle 12 into account, enabling delivery using the drone 50 to be optimized.

In the sorting processing of the present exemplary embodiment, in addition to the environment around the vehicle 12, information relating to the delivery site D, such as the state of the travel path and the elevation of the delivery site D, can be employed in the travel viability determination as to whether or not travel of the traveling robot 40 is viable. In the vehicle 12 of the present exemplary embodiment, the viability of movement of the traveling robot 40 is determined taking the information relating to the delivery site D and the environment around the vehicle 12 into account, enabling delivery using the traveling robot 40 to be optimized.

In the delivery system 10 of the present exemplary embodiment, a determination as to which out of the traveling robot 40 or the drone 50 would deliver most efficiently depending on factors such as the weather and state of the travel path is made in consideration of the position information of the vehicle 12, and the package P is sorted according to this determination. This enables more efficient delivery.

Note that in the sorting processing of the present exemplary embodiment, the drone 50 may be prioritized in a case in which the traveling robot 40 is out making a delivery, and the traveling robot 40 may be prioritized in a case in which the drone 50 is out making a delivery.

Moreover, in the sorting processing of the present exemplary embodiment, in a case in which travel of the traveling robot 40 is viable and flight of the drone 50 is also viable, delivery of the package P by the drone 50 is prioritized. However, there is no limitation thereto, and for example in a case in which the user C has preselected either the traveling robot 40 or the drone 50 as a delivery method, delivery by the traveling robot 40 or the drone 50 may be prioritized based on this selection.

In the vehicle 12 of the present exemplary embodiment, the traveling robot 40 that descends onto the travel path from the vehicle 12 is accommodated at the vehicle lower side of the cabin 21, and the drone 50 that flies into the air above the vehicle 12 is accommodated at the vehicle upper side of the cabin 21. Namely, in the present exemplary embodiment, each moving body (the traveling robot 40 and the drone 50) can be provided with an in-vehicle space appropriate for its movement characteristics. Moreover, in the present exemplary embodiment, each moving body (the traveling robot 40 and the drone 50) has a dedicated standby space inside the cabin 21, such that the package P is kept dry during wet weather.

In the vehicle 12 of the present exemplary embodiment, a package P is moved from the sorting operation area 24A of the sorting room 24 toward the drone bay 34 by being slid in a horizontal direction, whereas a package P is moved from the sorting operation area 24A toward the vehicle bay 32 by being lowered in a vertical direction. Namely, in the present exemplary embodiment, packages P are moved in different directions (a horizontal direction or a vertical direction) from the sorting room 24, enabling more efficient sorting of the packages P.

In the delivery system 10 of the present exemplary embodiment, in a case in which travel of the traveling robot 40 is not viable and flight of the drone 50 is likewise not viable, the user C can be prompted to come to the vehicle 12 for collection. The present exemplary embodiment is capable of providing the user with a package delivery method even if movement of both moving bodies is not viable.

Moreover, in the delivery system 10 of the present exemplary embodiment, the user C can be provided with an incentive to come and collect the package P, for example in the form of points that can be converted into cash. This enables the effort spent on redelivery to be lessened.

### Second Exemplary Embodiment

In the first exemplary embodiment, the flight viability determination section 260 of the controller 200 of the vehicle 12 executes the flight viability determination. However, in a second exemplary embodiment, the controller 500 of the drone 50 is capable of executing the flight viability determination. Note that in the present exemplary embodiment, configurations other than the functional configuration of the CPU 501 are the same as those of the first exemplary embodiment, and so explanation regarding the respective configurations will be omitted.

In the present exemplary embodiment, the drone 50 accommodated in the drone bay 34 acquires the environment at the vehicle 12 exterior through the window 20C of the hinged door 20B that configures a wall of the drone bay 34 (see FIG. 3). Specifically, the environmental sensor 520 provided to the drone 50 acquires information obtained through the window 20C.

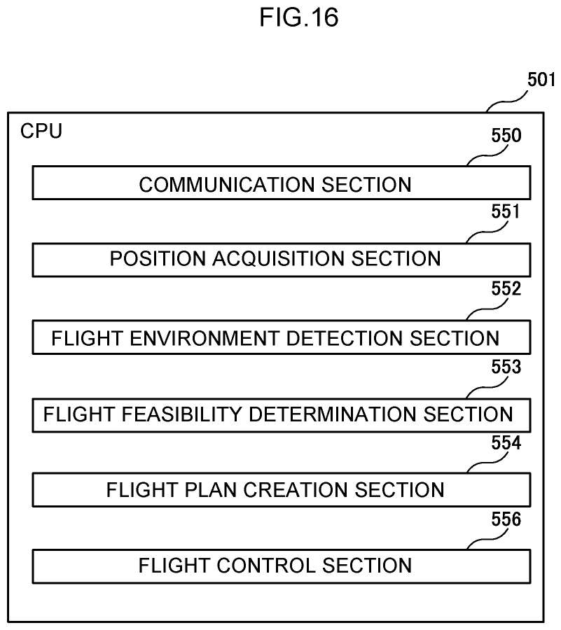

FIG. 16 is a block diagram illustrating an example of functional configuration of the CPU 501 of the present exemplary embodiment. As illustrated in FIG. 16, the CPU 501 includes a flight feasibility determination section 553 in addition to the communication section 550, the position acquisition section 551, the flight environment detection section 552, the flight plan creation section 554, and the flight control section 556.

The flight feasibility determination section 553 has a function of performing flight feasibility determination as to whether or not flight of the drone 50 is viable. Specifically, the flight feasibility determination section 553 determines whether or not flight of the drone 50 is viable based on at least the flight environment information for the surroundings acquired from the environmental sensor 520 of the drone 50. The “flight environment information” is as described above. For example, the flight feasibility determination section 553 determines that flight is not viable in cases in which strong winds or heavy rain can be detected from the flight environment information.

In addition to the flight environment information, the flight feasibility determination section 553 is also capable of employing attribute information relating to attributes of the package P in the flight feasibility determination. The “attribute information” is as described above. The attribute information may be acquired from a barcode or a two-dimensional code such as a QR code (registered trademark) displayed on the package P, or may be acquired from the processing server 14. For example, based on the attribute information, in cases in which the package P has a size or shape that would not fit in the storage compartment 54, or in a case in which the weight of the package P exceeds a viable flying weight of the drone 50, or in a case in which the package P is vulnerable to changes in air pressure, the flight feasibility determination section 553 determines that flight is not viable.

Explanation follows regarding sorting processing of the present exemplary embodiment where different to the sorting processing of the first exemplary embodiment described above (see FIG. 14). The processing of step S100 to step S103 of the sorting processing of the present exemplary embodiment is the same as that in the first exemplary embodiment.

At step S104, the CPU 201 acquires the flight viability information, this being the result of the flight feasibility determination executed by the CPU 501, from the drone 50. Processing then proceeds to the next step S105.

Subsequent processing in the sorting processing, from step S105 to step S112, is the same as that of the first exemplary embodiment.

The delivery system 10 of the present exemplary embodiment described above is capable of employing the flight environment information, including weather conditions, required for autonomous steering of the drone 50 in the flight feasibility determination as to whether or not flight of the drone 50 is viable. In the present exemplary embodiment, determination as to whether or not flight of the drone 50 is viable is made taking the environment around the drone 50 into account, and the traveling robot 40 can be utilized in a case in which flight is not viable.

In the delivery system 10 of the present exemplary embodiment, in addition to the environment around the drone 50, attributes such as the size, shape, weight, contents of the package P can be employed in the flight feasibility determination as to whether or not flight of the drone 50 is viable. In the present exemplary embodiment, determination as to whether or not flight of the drone 50 is viable is made taking the attributes of the package P and the environment around the drone 50 into account, enabling delivery using the drone 50 to be optimized.

### Third Exemplary Embodiment

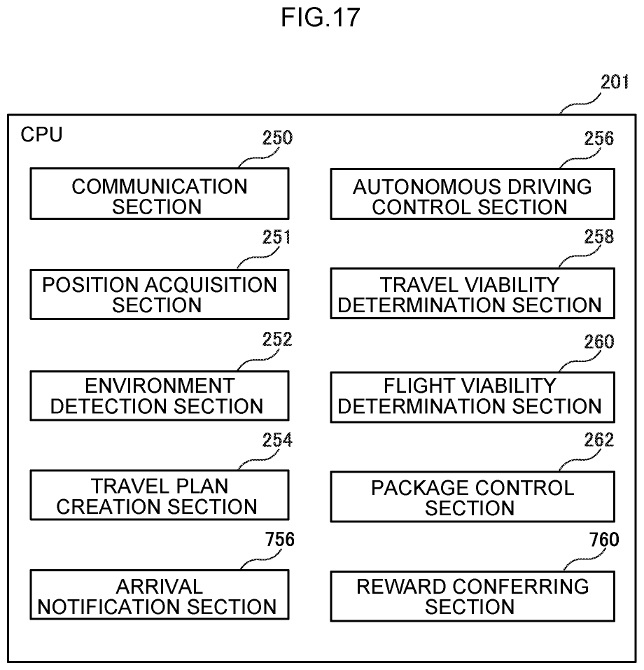

In the exemplary embodiments described above, the notification processing is executed by the processing server 14. However, there is no limitation thereto. In a third exemplary embodiment, the controller 200 is provided with an arrival notification section to notify the user C of the arrival of the package P, and the notification processing is executed by the vehicle 12. Specifically, as illustrated in FIG. 17, the CPU 201 includes the communication section 250, the position acquisition section 251, the environment detection section 252, the travel plan creation section 254, the autonomous driving control section 256, the travel viability determination section 258, the flight viability determination section 260, the package control section 262, the arrival notification section 756, and the reward conferring section 760. In the present exemplary embodiment, processing relating to delivery of a package P can be fully performed between the vehicle 12 and the smartphone 16, without going through the processing server 14.

Notes

In the respective exemplary embodiments, the package P is sorted for either the traveling robot 40 or the drone 50. However, there is no limitation thereto, and in cases in which plural packages P are present, the traveling robot 40 and the drone 50 may be employed in tandem to deliver the plural packages P to their delivery sites D.

In the respective exemplary embodiments, explanation has been given regarding the traveling robot 40 as an example of a ground-based moving body. However, there is no limitation thereto, and the ground-based moving body may be configured by a radio controlled car, ambulatory robot, or the like. Moreover, in the respective exemplary embodiments, explanation has been given regarding the drone 50 as an example of a flying moving body. However, there is no limitation thereto, and the flying moving body may be configured by a radio controlled plane, a radio controlled helicopter, or the like.

Note that the respective processing executed by the CPUs 201, 401, 501, and 701 of the exemplary embodiments described above reading and executing software (programs) may be executed by various processors other than CPUs. Examples of such processors include Programmable Logic Devices (PLDs) that enable post-manufacture circuit configuration modifications, such as a Field-Programmable Gate Array (FPGA), and processors such as Application Specific Integrated Circuits (ASICs) with custom-designed electrical circuit configurations for execution of specific processing. Moreover, sorting processing and notification processing may he executed by one of such various processors, or may he executed using a combination of two or more processors of the same type or of different types to each other (for example, by plural FPGAs, or by a combination of a CPU and an FPGA). More specific examples of the hardware structures of these various processors include electrical circuits configured by combining circuit devices such as semiconductor devices.

In the exemplary embodiments described above, explanation has been given which the respective programs are provided in a format pre-stored (installed) on a non-transient computer-readable recording medium. For example, the execution program of the vehicle 12 is pre-stored in the ROM 202, and the execution program of the traveling robot 40 is pre-stored in the ROM 402. Moreover, for example, the execution program of the drone 50 is pre-stored in the ROM 502, and the processing program of the processing server 14 is pre-stored in the storage 704. However, there is no limitation thereto, and the respective programs may be provided in a format stored on a non-transient recording medium such as Compact Disc Read Only Memory (CD-ROM), Digital Versatile Disc Read Only Memory (DVD-ROM), or Universal Serial Bus (USB) memory. The programs may also be in a format to be downloaded from an external device over a network.

The processing flows in the exemplary embodiments described above are merely exemplary, and unnecessary steps may be removed, new steps may be added, and the processing sequence may be changed within a range not departing from the spirit of the present disclosure.

Other configurations of the respective controllers, the processing server, the smartphone, and the like in the exemplary embodiments described above are merely exemplary, and may be modified according to circumstances within a range not departing from the spirit of the present disclosure.

What is claimed is:

1. A vehicle comprising:
a first bay configured to accommodate a ground-based moving body;
a second bay configured to accommodate a flying moving body;
a cargo hold connected to both the first bay and the second bay, and configured to store a package to be moved to either the ground-based moving body or the flying moving body;
a first memory; and
a first processor connected to the first memory,
the first processor being configured to select whether to move the package in the cargo hold to the ground-based moving body or the flying moving body.

2. The vehicle of claim 1, wherein:
the vehicle is an autonomous vehicle; and
the first processor is configured to:
acquire position information relating to the vehicle,
detect travel environment information relating to surroundings of the vehicle,
create a travel plan, and
determine whether or not flight of the flying moving body is viable based on at least one of the position information, the travel environment information, or the travel plan.

3. The vehicle of claim 2, wherein the first processor is further configured to determine whether or not flight of the flying moving body is viable based on attribute information relating to an attribute of the package.

4. The vehicle of claim 1, wherein:
the vehicle is an autonomous vehicle; and
the first processor is configured to:
acquire position information relating to the vehicle,
detect travel environment information relating to surroundings of the vehicle,
create a travel plan, and
determine whether or not movement of the ground-based moving body is viable based on delivery site information relating to a delivery site of the package, and at least one of the position information, the travel environment information, or the travel plan.

5. The vehicle of claim 1, wherein:
the first bay is disposed at a vehicle lower side of the cargo hold; and
the second bay is disposed further toward a vehicle upper side than the first bay.

6. The vehicle of claim 5, further comprising:
a sorting room that is disposed in the cargo hold so as to be adjacent to both the first bay and the second bay, and in which the package, when stored, is sorted for either the ground-based moving body or the flying moving body,
wherein the sorting room sorts by moving the package toward a vehicle lower side toward the ground-based moving body, or by sliding the package toward the flying moving body.

7. The vehicle of claim 1, wherein the first processor is configured to move the package in the cargo hold to the flying moving body in preference to the ground-based moving body in a case in which movement of the ground-based moving body is viable and flight of the flying moving body is also viable.

8. The vehicle of claim 1, wherein the first processor is configured to notify a user corresponding to a delivery site of the package of arrival of the package in a case in which movement of the ground-based moving body is not viable and flight of the flying moving body is not viable, when a position of the vehicle is also proximate to the delivery site of the package.

9. A delivery system comprising:
the vehicle of claim I, the ground-based moving body, and the flying moving body,
the vehicle including a window in a wall of the second bay,
the flying moving body including a second memory and a second processor connected to the second memory, and
the second processor being configured to:
detect flight environment information relating to surroundings of the flying moving body through the window, and
determine whether or not flight of the flying moving body is viable based on the flight environment information.

10. The delivery system of claim 9, wherein the second processor is further configured to determine whether or not flight of the flying moving body is viable based on attribute information relating to an attribute of the package.

11. A delivery system comprising:
a ground-based moving body, a flying moving body, a vehicle configured to accommodate the ground-based moving body and the flying moving body and configured to store a package capable of being transferred to the ground-based moving body or the flying moving body, and a processing server capable of communicating with at least the vehicle,
the processing server including:
a memory, and
a processor connected to the memory; and
the processor being configured to:
acquire, from the vehicle, movement viability information relating to the ground-based moving body and flight viability information relating to the flying moving body,
acquire position information relating to a position of the vehicle, and
notify a user corresponding to a delivery site of the package of arrival of the package in a case in which the movement viability information indicates that movement is not viable and the flight viability information indicates that flight is not viable, when the position of the vehicle is also proximate to the delivery site of the package.

12. The delivery system of claim 11, wherein the processor is configured to confer a reward to the user enabling a product to be obtained in a case in which the user collects the package from the vehicle.
